(19) United States
(12) Patent Application Publication
(10) Pub. No.: US 2017/0285501 A1
(43) Pub. Date: Oct. 5, 2017

(54) IMAGE FORMING APPARATUS, ELECTROSTATIC CHARGE IMAGE DEVELOPING MAGENTA TONER, AND ELECTROSTATIC CHARGE IMAGE DEVELOPING TONER SET

(71) Applicant: FUJI XEROX CO., LTD., Tokyo (JP)

(72) Inventors: Kana YOSHIDA, Kanagawa (JP); Akira MATSUMOTO, Kanagawa (JP); Satoshi MIURA, Kanagawa (JP)

(73) Assignee: FUJI XEROX CO., LTD., Tokyo (JP)

(21) Appl. No.: 15/226,496

(22) Filed: Aug. 2, 2016

(30) Foreign Application Priority Data
Mar. 29, 2016 (JP) 2016-065158

(51) Int. Cl. G03G 9/00

(52) U.S. Cl. CPC G03G 9/0819; G03G 15/0822

(57) ABSTRACT

An image forming apparatus includes a first image forming unit that forms a yellow image by an electrostatic charge image developing yellow toner; a second image forming unit that forms a magenta image by an electrostatic charge image developing magenta toner; a transfer unit that transfers the yellow image and the magenta image to a recording medium; and a fixing unit that fixes the yellow image and the magenta image to the recording medium, wherein a maximum absorption wavelength λmax (M) of the electrostatic charge image developing magenta toner at a wavelength of 360 nm to 760 nm is from 530 nm to 580 nm, and when an absorbance of the maximum absorption wavelength λmax (M) is standardized to 1, an absorbance at a wavelength of 450 nm is 0.20 or less and an absorbance at a wavelength of 400 nm is 0.10 or less.

### CROSS-REFERENCE TO RELATED APPLICATIONS

This application is based on and claims priority under 35 USC 119 from Japanese Patent Application No. 2016-065158 filed Mar. 29, 2016.

### BACKGROUND

### 1. Technical Field

The present invention relates to an image forming apparatus, an electrostatic charge image developing magenta toner, and an electrostatic charge image developing toner set.

### 2. Related Art

In recent years, there has been a rapidly increasing demand for high-quality output images such as catalogs or brochures in the field of printing for the electrophotographic industry. Particularly, a red color has human identification capability and thus high saturation and excellent color reproducibility are required.

### SUMMARY

According to an aspect of the invention, there is provided an image forming apparatus including:

a first image forming unit that forms a yellow toner image by an electrostatic charge image developing yellow toner;

a second image forming unit that forms a magenta toner image by an electrostatic charge image developing magenta toner;

a transfer unit that transfers the yellow toner image and the magenta toner image to a recording medium; and

a fixing unit that fixes the yellow toner image and the magenta toner image to the recording medium,

wherein a maximum absorption wavelength λmax (M) of the electrostatic charge image developing magenta toner at a wavelength of 360 nm to 760 nm is from 530 nm to 580 nm, and

when an absorbance of the maximum absorption wavelength λmax (M) is standardized to 1, an absorbance at a wavelength of 450 nm is 0.20 or less and an absorbance at a wavelength of 400 nm is 0.10 or less.

### BRIEF DESCRIPTION OF THE DRAWINGS

Exemplary embodiments of the present invention will be described in detail based on the following figures, wherein:

FIG. 1 is a configuration view schematically showing an example of an image forming apparatus according to the present exemplary embodiment;

FIG. 2 is a configuration view schematically showing an example of a process cartridge according to the present exemplary embodiment;

FIG. 3 is a view schematically showing an example of an apparatus used for a power feed addition method; and

FIG. 4 is a diagram schematically showing an example of absorption spectra before and after attenuation of a magenta toner of the related art and a magenta toner of the present exemplary embodiment.

### DETAILED DESCRIPTION

Hereinafter, exemplary embodiments which are examples of the present invention will be described in detail.

Electrostatic Charge Image Developing Magenta Toner

An electrostatic charge image developing magenta toner (hereinafter, also referred to as a “magenta toner”) according to the present exemplary embodiment has a maximum absorption wavelength λmax (M) of 530 nm to 580 nm at a wavelength of 360 nm to 760 nm, and the absorbance at a wavelength of 450 nm is 0.20 or less and the absorbance at a wavelength of 400 nm is 0.10 or less when the absorbance of the maximum absorption wavelength λmax (M) is standardized to 1.

Hereinafter, the maximum absorption wavelength at a wavelength of 360 nm to 760 nm is also simply referred to as the “maximum absorption wavelength”. Further, when the absorbance of the maximum absorption wavelength λmax is standardized to 1, this absorbance is also referred to as a “standardized absorbance”.

In the magenta toner according to the present exemplary embodiment, a change in color tone of a red color image in a state of being exposed to sunlight for a long period of time (for example, 500 hours) is prevented when the red color image is formed as a secondary color using a combination with a yellow toner. The reason thereof is not clear, but is assumed as follows.

It is considered that a red color image obtained as a secondary color between a yellow toner and a magenta toner holds absorption typically in a wavelength range of 450 nm to 600 nm and the color tone of the red color image is easily and greatly affected by the absorbance in this range. When the red color image is continuously exposed to sunlight, a reduction in light absorption amount occurs due to decomposition of a colorant and thus the color tone of the red color image is changed in some cases.

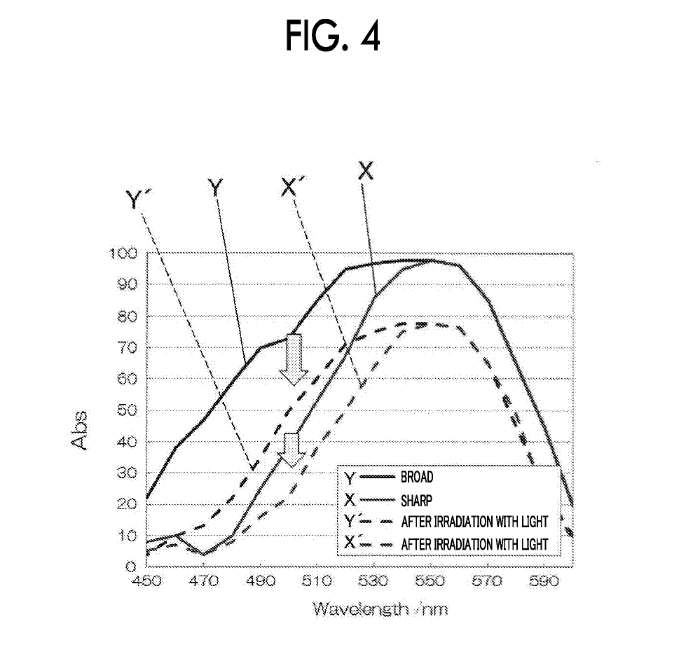

FIG. 4 schematically shows an example of absorption spectra before and after attenuation of a magenta toner of the related art and the magenta toner of the present exemplary embodiment.

As indicated by a solid line Y of FIG. 4, when a short wavelength side of the maximum absorption wavelength due to a magenta colorant is broad, a large absorption peak is considered to be present outside the range of 500 nm to 600 nm. Moreover, as indicated by a dotted line Y′ of FIG. 4, when the entire wavelength is attenuated due to the irradiation with light for a long period of time, the broad portion on the short wavelength side is more affected and attenuated compared to the maximum absorption wavelength side. As a result, the color tone of the red color obtained as a secondary color that is greatly affected by the wavelength in the vicinity thereof is deviated.

The magenta toner according to the present exemplary embodiment has a maximum absorption wavelength λmax (M) of 530 nm to 580 nm at a wavelength of 360 nm to 760 nm, and the absorbance at a wavelength of 450 nm is 0.20 or less and the absorbance at a wavelength of 400 nm is 0.10 or less when the absorbance of the maximum absorption wavelength λmax (M) is standardized to 1. As indicated by a solid line X of FIG. 4, the absorption wavelength is sharp and the broad portion of the short wavelength side has a few additional absorption wavelengths compared to the maximum absorption wavelength side.

When a red color image having a red color obtained as a secondary color between a yellow toner and the magenta toner according to the present exemplary embodiment, in which the shape of the absorption spectrum in the vicinity of the maximum absorption wavelength is sharp, is formed, decomposition of a colorant due to the exposure to sunlight proceeds, and the short wavelength side, which is irradiated with a great intensity of energy and strongly affected by decomposition of a coloring material compared to the maximum absorption wavelength side, is less attenuated even when the light absorption amount resulting from the magenta toner indicated by a dotted line X′ of FIG. 4 is reduced. Therefore, it is assumed that deviation of the color tone of the red color obtained as a secondary color is prevented because a change in shape of the absorption spectrum of magenta is prevented.

In the magenta toner according to the present exemplary embodiment, in the absorption spectrum in which the absorbance of the maximum absorption wavelength λmax (M) at a wavelength of 360 nm to 760 nm is standardized to 1, a change in color tone of a formed red color image in a state of being exposed to sunlight for a long period of time is further prevented when the full width at half maximum of the absorption peak in the maximum absorption wavelength λmax (M) (hereinafter, also simply referred to as the “full width at half maximum”) is 100 nm or less. The reason thereof is assumed as follows.

In the magenta toner according to the present exemplary embodiment, the absorption spectrum on the short wavelength side becomes sharper when the full width at half maximum is 100 nm or less, compared to a case where the full width at half maximum exceeds 100 nm. Further, it is considered that attenuation of the wavelength in the vicinity thereof is further prevented even after a light fastness test and thus deviation of the color tone may be further reduced because absorption wavelengths are further reduced in a wavelength region of 500 nm to 600 nm.

In addition, the maximum absorption wavelength λmax (M) of the magenta toner according to the present exemplary embodiment is preferably from 530 nm to 580 nm and more preferably from 540 nm to 570 nm. The standardized absorbance at a wavelength of 450 nm is preferably 0.20 or less and more preferably 0.15 or less and the standardized absorbance at a wavelength of 400 nm is preferably 0.10 or less and more preferably 0.05 or less.

Further, the full width at half maximum of the magenta toner according to the present exemplary embodiment is preferably from 10 nm to 100 nm and more preferably from 15 nm to 90 nm.

Moreover, in the magenta toner according to the present exemplary embodiment, the standardized absorbance at a wavelength of 380 nm is preferably 0.10 or less and more preferably 0.05 or less. In the magenta toner according to the present exemplary embodiment, the standardized absorbance at a wavelength of 620 nm is preferably 0.20 or less and more preferably 0.15 or less.

Here, the maximum absorption wavelength λmax at a wavelength of 360 nm to 760 nm, the standardized absorbance at a specific wavelength, and the full width at half maximum of the toner according to the present exemplary embodiment are measured as follows.

0.01 g of a toner and 60 mL of ISOTON containing DOW FAX are mixed with each other and 200 mL of ion exchange water is added thereto. The solution is filtered using a cellulose acetate filter (0.2 μm) and allowed to stand for 1 minute, and the filter is taken out, thereby obtaining an evaluation sample.

Further, the absorption spectrum is measured for each 10 nm in a wavelength region of 360 nm to 730 nm using a spectrophotometer (ULTRA SCAN PRO, manufactured by Hunter Associates Laboratory, Inc.).

Hereinafter, the magenta toner according to the present exemplary embodiment will be described in detail.

The magenta toner according to the present exemplary embodiment includes toner particles and, if necessary, external additives.

Toner Particles

The toner particles constituting the magenta toner according to the present exemplary embodiment (hereinafter, also referred to as “magenta toner particles”) include a binder resin, a magenta colorant as a colorant, and if necessary, a release agent or other additives.

Binder Resin

Examples of the binder resin include a homopolymer of monomers such as styrenes (for example, styrene, para-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenically unsaturated nitriles (for example, acrylonitrile, methacrylonitrile, or the like), vinyl ethers (for example, vinyl methyl ether, vinyl isobutyl ether, or the like), vinyl ketones (vinyl methyl ketone, vinyl ethyl ketone, vinyl isopropenyl ketone, or the like), olefins (for example, ethylene, propylene, butadiene, or the like), or vinyl resins formed of copolymers obtained by combining two or more kinds of these monomers.

Examples of the binder resin also include a non-vinyl resin such as an epoxy resin, a polyester resin, a polyurethane resin, a polyamide resin, a cellulose resin, a polyether resin, and a modified resin, a mixture of these and the vinyl resins, graft polymers obtained by polymerizing a vinyl monomer in the co-presence of these.

These binder resins may be used alone or in combination with two or more kinds thereof.

As the binder resin, a polyester resin is preferable.

Examples of the polyester resin include known polyester resins.

Examples of the polyester resin include condensation polymers of polyvalent carboxylic acids and polyols. As the polyester resin, commercially available products may be used and synthetic products may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, bisphenol A ethylene oxide adduct and bisphenol A propylene oxide adduct). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is determined by a DSC curve obtained by differential scanning calorimetry (DSC), and more specifically, is determined by “Extrapolated Starting Temperature of Glass Transition” disclosed in a method of determining a glass transition temperature of JIS K 7121-1987 “Testing Methods for Transition Temperature of Plastics”.

The weight average molecular weight (Mw) of the polyester resin is preferably from 5,000 to 1,000,000 and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100 and more preferably from 2 to 60.

The weight molecular weight and the number average molecular weight are measured by gel permeation chromatography (GPC). The molecular weight measurement by GPC is carried out by using GPC·HLC-8120GPC manufactured by Tosoh Corporation as a measuring device, TSKGEL SUPER HM-M (15 cm) manufactured by Tosoh Corporation, as a column, and a THF solvent. The weight molecular weight and the number average molecular weight are calculated using a calibration curve of molecular weight created with a monodisperse polystyrene standard sample from the measurement results.

A known preparation method is applied to obtain the polyester resin. Specific examples thereof include a method of conducting a reaction at a polymerization temperature set to from 180° C. to 230° C., if necessary, under reduced pressure in the reaction system, while removing water or an alcohol produced during condensation.

In the case in which monomers of the raw materials are not dissolved or compatibilized under a reaction temperature, a high-boiling-point solvent may be added as a solubilizing agent to dissolve the monomers. In this case, a polycondensation reaction is carried out while distilling away the solubilizing agent. In the case in which a monomer having poor compatibility is present in a copolymerization reaction, the monomer having poor compatibility and an acid or an alcohol to be polycondensed with the monomer may be previously condensed and then polycondensed with the main component.

The content of the binder resin is, for example, preferably from 40% by weight to 95% by weight, more preferably from 50% by weight to 90% by weight, and still more preferably from 60% by weight to 85% by weight with respect to the entire toner particles.

—Colorant—

The magenta toner particles according to the present exemplary embodiment include a magenta colorant as a colorant. The magenta colorant included in the magenta toner particles according to the present exemplary embodiment is not particularly limited as long as the magenta toner according to the present exemplary embodiment exhibits an absorption spectrum (hereinafter, also referred to as a “specific absorption spectrum”) in which the maximum absorption wavelength λmax (M) at a wavelength of 360 nm to 760 nm is from 530 nm to 580 nm and the absorbance at a wavelength of 450 nm exceeds 0.20 and the absorbance at a wavelength of 400 nm exceeds 0.10 when the absorbance of the maximum absorption wavelength λmax (M) is standardized to 1.

As the magenta colorant included in the magenta toner particles according to the present exemplary embodiment, an organic colorant having a molecular framework in which a coupling site and a functional group having an unshared electron pair are close to each other is preferable. Examples of the functional group having an unshared electron pair include a nitrogen-containing functional group and an oxygen-containing functional group. Examples of the coupling site include an aromatic ring, a heterocycle, an alkene, and an alkyne.

Examples of the magenta colorant included in the magenta toner particles according to the present exemplary embodiment include a β-naphthol pigment, an azo lake pigment, a quinacridone pigment, a disazo pigment, a benzimidazolone pigment, a diazo condensation pigment, a dioxazine pigment, and a diketopyrrolopyrrole pigment. Examples of the magenta toner particles according to the present exemplary embodiment may include one or two or more magenta colorants. Specific examples of the magenta colorant which may be included in the magenta toner particles according to the present exemplary embodiment include β-naphthol pigments such as C. I. Pigment Red 146, 2, 5, 7, 8, 9, 10, 11, 12, 13, 14, 15, 16, 17, 18, 21, 22, 23, 31, 32, 95, 112, 114, 119, 136, 147, 148, 150, 164, 170, 184, 187, 188, 210, 212, 213, 222, 223, 238, 245, 253, 256, 258, 261, 266, 267, 268, and 269; azo lake pigments such as C. I. Pigment Red 57:1, 18:1, 48:2, 48:3, 48:4, 48:5, 50:1, 51, 52:1, 52:2, 53:1, 53:2, 53:3, 58:2, 58:4, 64:1, 68, and 200; quinacridone pigments such as C. I. Pigment Red 209, 122, 192, 202, 207, and C. I. pigment Violet 19; diazo pigments such as C. I. Pigment Red 37, 38, 41, 111, C. I. Pigment Orange 13, 15, 16, 34, and 44; benzimidazolone pigments such as C. I. Pigment Red 171, 175, 176, 185, 208, C. I. Pigment Violet 32, C. I. Pigment Orange 36, 60, 62, and 72; diazo condensation pigments such as C. I. Pigment Red 144, 166, 214, 220, 221, 242, 248, 262, and C. I. Pigment Orange 31; dioxazine pigments such as C. I. Pigment Violet 23 and 37; and diketopyrrolopyrrole pigments such as C. I. Pigment Red 254, 255, 264, 272, C. I. Pigment Orange 71, and 73.

Here, the “C. I.” indicates “Colour Index”. In the present specification, “C. I. Pigment Red” is also noted as “pigment red” or “PR”. From the viewpoint of exhibiting the specific absorption spectrum, PR 122 and PR 185 are more preferable.

Moreover, the magenta toner according to the present exemplary embodiment may include another colorant other than the magenta colorant unless the specific absorption spectrum is exhibited. In this case, the content of another colorant is preferably 10% by weight or less and more preferably 5% by weight or less with respect to the total content of colorants. Further, it is still more preferable that another colorant is not used.

As a magenta colorant in which the maximum absorption wavelength, the standardized absorbance at a wavelength of 450 nm, and the standardized absorbance at a wavelength of 400 nm are respectively in the above-described ranges, commercially available magenta pigments subjected to a treatment according to a specific treatment method described below may be exemplified.

A method of dispersing a magenta colorant in an aqueous dispersion medium including a surfactant, performing separation using a centrifugal separator to collect the supernatant thereof may be exemplified as the specific treatment method. A magenta colorant in which the maximum absorption wavelength, the standardized absorbance at a wavelength of 450 nm, and the standardized absorbance at a wavelength of 400 nm are respectively in the above-described ranges is obtained from the supernatant.

As the aqueous dispersion medium and the surfactant used for the specific treatment method, those which are the same used for preparing a typical colorant particle dispersion may be used.

Examples of the aqueous dispersion medium include water such as distilled water or ion exchange water, and alcohols. These may be used alone or in combination of two or more kinds thereof.

Examples of the surfactant include anionic surfactants such as sulfuric ester salts, sulfonates, phosphoric esters and soap surfactants; cationic surfactants such as amine salts and quaternary ammonium salts; and nonionic surfactants such as polyethylene glycol, alkylphenol ethylene oxide adducts and polyols. Among these, particularly, anionic surfactants and cationic surfactants are preferable. The nonionic surfactants may be used in combination with anionic surfactants or cationic surfactants.

The surfactants may be used alone or in combination of two or more kinds thereof.

The amount of the surfactant to be added may be from 1 part by weight to 80 parts by weight, is preferably from 5 parts by weight to 50 parts by weight, and more preferably from 10 parts by weight to 30 parts by weight with respect to 100 parts by weight of the magenta colorant.

As the method of dispersing a magenta colorant in an aqueous dispersion medium using a specific treatment method, dispersion methods using a rotary shear type homogenizer, a high pressure impact type disperser, a ball mill, a sand mill, or a dynomill having media may be exemplified. Further, these methods may be used in combination.

In this case, from the viewpoint that the maximum absorption wavelength λmax (M) of a toner is set to be in the above-described range, it is preferable that the magenta colorant is dispersed in an aqueous dispersion medium according to the same method as that for preparing a typical colorant particle dispersion and then further treated using a high pressure impact type disperser. The pressure during the treatment carried out using a high pressure impact type disperser may be from 200 MPa to 300 MPa, and the number of passes may be in a range of 5 to 50.

Further, the separation using a centrifugal separator may be performed under the conditions of a gravity acceleration of 3×10⁴ G to 5×10⁶ G for a centrifugation time of 10 minutes to 600 minutes.

The volume average particle diameter of the magenta colorant treated by the specific treatment method may be from 70 nm to 300 nm, is preferably from 80 nm to 200 nm, and more preferably from 100 nm to 150 nm.

The volume average particle diameter of the magenta colorant is measured using the particle size distribution measured by a laser diffraction particle size distribution measuring device (LA-700, manufactured by Horiba, Ltd.), a cumulative distribution is drawn from the small diameter side with respect to the volume based on the divided particle diameter ranges (channels), and the particle diameter at which the cumulative volume distribution reaches 50% of the total particle volume is defined as a volume average particle diameter D50v. Hereinafter, the volume average particle diameter of particles in the other dispersion will be measured in the same manner. With a measurement sample, particle size distribution is calculated by setting an input value of the refractive index of a dispersion medium as 1.333 and setting an input value of the refractive index of particles (magenta colorant) as 1.676 using a dispersion in which the magenta colorant is dispersed in the aqueous dispersion medium as a measurement sample.

The specific weight of the magenta colorant treated by the specific treatment method may be from 1.00 to 1.30, is preferably from 1.00 to 1.20, and more preferably from 1.00 to 1.10.

Further, the specific weight thereof is measured using a specific weight measuring kit AD1653 (manufactured by A & D Company, Ltd.).

D84v/D50v of the magenta colorant treated by the specific treatment method may be from 1.00 to 2.00, is preferably in a range of 1.00 to 1.60, more preferably from 1.00 to 1.41, and still more preferably from 1.00 to 1.30.

Further, D84v/D50v described above is determined from values obtained by measuring the volume average particle diameter of the magenta colorant. Specifically, a cumulative distribution is drawn from the small diameter side with respect to the volume based on the divided particle size ranges (channels), the particle diameter at which the cumulative volume distribution reaches 84% of the total particle volume is defined as “D84v”, and the particle diameter at which the cumulative volume distribution reaches 50% of the total particle volume is defined as “D50v”, and then the value of “D84v/D50v” is determined.

The content of the colorant is, for example, preferably from 1% by weight to 30% by weight and more preferably from 3% by weight to 15% by weight with respect to the entire magenta toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C. and more preferably from 60° C. to 100° C.

The melting temperature is obtained from “melting peak temperature” described in the method of obtaining a melting temperature in JIS K7121-1987 “testing methods for transition temperatures of plastics”, from a DSC curve obtained by differential scanning calorimetry (DSC).

The content of the release agent is, for example, preferably from 1% by weight to 20% by weight and more preferably from 5% by weight to 15% by weight with respect to the entire toner particles.

Other Additives

Examples of other additives include known additives such as a magnetic material, a charge-controlling agent, and an inorganic powder. The toner particles contain these additives as internal additives.

Characteristics of Toner Particles or the like

The toner particles may be toner particles having a single-layer structure, or toner particles having a so-called core/shell structure formed of a core (core particle) and a coating layer (shell layer) to be applied to the core.

Here, toner particles having a core/shell structure may be formed of, for example, a core containing a binder resin, and if necessary, other additives such as a colorant and a release agent, and a coating layer containing a binder resin.

The volume average particle diameter (D₅₀ᵥ) of the toner particles is preferably from 2 μm to 10 μm and more preferably from 4 μm to 8 μm.

Various average particle diameters and various particle diameter distribution indices of the toner particles are measured using a COULTER MULTISIZER II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of a surfactant (preferably sodium alkylbenzene sulfonate) as a dispersing agent. The obtained material is added to from 100 ml to 150 ml of the electrolyte.

The electrolyte in which the sample is suspended is subjected to a dispersion treatment using an ultrasonic disperser for 1 minute, and a particle diameter distribution of particles having a particle diameter of from 2 μm to 60 μm is measured by a COULTER MULTISIZER II using an aperture having an aperture diameter of 100 μm. 50,000 particles are sampled.

Cumulative distributions by volume and by number are drawn from the side of the smallest diameter with respect to particle diameter ranges (channels) divided based on the measured particle diameter distribution. The particle diameter when the cumulative percentage becomes 16% is defined as that corresponding to a volume average particle diameter D16v and a number average particle diameter D16p, while the particle diameter when the cumulative percentage becomes 50% is defined as that corresponding to a volume average particle diameter D50v and a number average particle diameter D50p. Furthermore, the particle diameter when the cumulative percentage becomes 84% is defined as that corresponding to a volume average particle diameter D84v and a number average particle diameter D84p.

Using these, a volume average particle diameter distribution index (GSDv) is calculated as (D84v/D16v)^{1/2}, while a number average particle diameter distribution index (GSDp) is calculated as (D84p/D16p)^{1/2}.

A shape factor SF1 of the toner particles is preferably from 110 to 150 and more preferably from 120 to 140.

In addition, the shape factor SF1 is determined using the following equation.

SF1=(ML²/A)×(π/4)×100 Equation:

In the equation, ML represents a maximum absolute length of a toner and A represents a projected area of a toner.

Specifically, the shape factor SF1 is digitized by mainly analyzing a microscope image or a scanning electron microscope (SEM) image using an image analyzer and is calculated as follows. That is, an optical microscope image of particles sprayed on the surface of slide glass is captured in an image analyzer (LUZEX) by a video camera, the maximum length and the projected area of one hundred particles are determined, and calculation is performed using the above equation, and then the average value thereof is determined, thereby obtaining the shape factor.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

It is preferable that the surface of the inorganic particles serving as the external additive is subjected to a hydrophobizing treatment. The hydrophobizing treatment is carried out by, for example, dipping the inorganic particles in a hydrophobizing agent. The hydrophobizing agent is not particularly limited and examples thereof include a silane coupling agent, a silicone oil, a titanate coupling agent, and an aluminum coupling agent. These agents may be used alone or in combination of two or more kinds thereof.

For example, the amount of the hydrophobizing agent is typically from 1 part by weight to 10 parts by weight with respect to 100 parts by weight of the inorganic particles.

Examples of the external additive include resin particles (resin particles of polystyrene, polymethyl methacrylate (PMMA), melamine resin, and the like), and a cleaning aid (for example, particles of a higher fatty acid metal salt represented as zinc stearate and a fluorine polymer).

The amount of the external additive externally added is, for example, preferably from 0.01% by weight to 5% by weight and more preferably from 0.01% by weight to 2.0% by weight with respect to the toner particles.

Preparing Method of Toner

Next, the method of preparing the toner according to the exemplary embodiment will be described.

The toner according to the exemplary embodiment may be obtained by preparing toner particles and then adding an external additive to the toner particles.

The toner particles may be prepared by any of a dry method (for example, a kneading and pulverizing method or the like), and a wet method (for example, an aggregation and coalescence method, a suspension polymerization method, a dissolution suspension method, or the like). The preparation of the toner particles is not particularly limited to these methods and a known method may be employed.

Among these, the toner particles are preferably obtained by the aggregation and coalescence method.

Specifically, for example, in the case of preparing the toner particles by the aggregation and coalescence method, the toner particles are prepared through a process of preparing a resin particle dispersion in which resin particles which become a binder resin are dispersed (resin particle dispersion preparation process), a process of forming aggregated particles by aggregating the resin particles (if necessary, other particles) in the resin particle dispersion (if necessary, in the dispersion after other particle dispersions are mixed), (aggregated particle forming process), and a process of forming toner particles by heating an aggregated particle dispersion in which the aggregated particles are dispersed to coalesce the aggregated particles (coalescing process).

Hereinafter, each process will be described in detail.

While a method of obtaining toner particles containing a colorant and a release agent will be described in the following description, the colorant and the release agent are used if necessary. Any additive other than colorants and release agents may, of course, be used.

Resin Particle Dispersion Preparation Process

First, along with a resin particle dispersion in which resin particles which becomes a binder resin are dispersed, for example, a colorant particle dispersion in which colorant particles are dispersed, and a release agent particle dispersion in which release agent particles are dispersed are prepared.

Herein, the resin particle dispersion is prepared, for example, by dispersing the resin particles in a dispersion medium by aid of a surfactant.

An example of the dispersion medium used in the resin particle dispersion includes an aqueous medium.

Examples of the aqueous medium include water such as distilled water and ion exchange water, and alcohols and the like. These may be used alone or in combination of two or more kinds thereof.

Examples of the surfactant include anionic surfactants such as sulfuric ester salts, sulfonates, phosphoric esters and soap surfactants; cationic surfactants such as amine salts and quaternary ammonium salts; and nonionic surfactants such as polyethylene glycol, alkylphenol ethylene oxide adducts and polyols. Among these, particularly, anionic surfactants and cationic surfactants are preferable. The nonionic surfactants may be used in combination with anionic surfactants or cationic surfactants.

The surfactants may be used alone or in combination of two or more kinds thereof.

In the resin particle dispersion, the resin particles may be dispersed in the dispersion medium by a general dispersion method, for example, by using a rotary shear type homogenizer, or a ball mill, a sand mill, or a DYNO mill having media. Further, depending on the kind of resin particles, the resin particles may be dispersed in the resin particle dispersion, for example, by a phase inversion emulsification method.

The phase inversion emulsification method is a method in which a resin to be dispersed is dissolved in a hydrophobic organic solvent capable of dissolving the resin, abase is added to the organic continuous phase (O phase) to neutralize the resin, an aqueous medium (W phase) is added to invert the resin into a discontinuous phase from W/O to O/W (so-called phase inversion), so that the resin may be dispersed in the form of particles in the aqueous medium.

The volume average particle diameter of the resin particles dispersed in the resin particle dispersion is, for example, preferably from 0.070 μm to 1.000 μm, more preferably from 0.075 μm to 0.500 μm, and still more preferably from 0.080 μm to 0.200 μm.

When the volume average particle diameter D50v of the resin particles is 0.070 μm or greater, the solution viscosity at the time of preparing toner particles is prevented to be low and particle size distribution of the toner particles to be finally obtained is likely to be narrow. It is effective that the volume average particle diameter D50v of the resin particles is in the above-described range from the viewpoints that uneven distribution of colorant particles among toner particles is prevented, the dispersion of the colorant particles in the toner particles becomes excellent, and a variation in performance or reliability is decreased. Further, the volume average particle diameter of the resin particles may be measured using a laser diffraction particle size distribution measuring device (LA-700, manufactured by Horiba, Ltd.).

For example, the content of the resin particles contained in the resin particle dispersion is preferably from 5% by weight to 50% by weight and more preferably from 10% by weight to 40% by weight.

For example, the colorant particle dispersion and the release agent particle dispersion may be prepared in a manner similar to the dispersion of resin particles. That is, with respect to the volume average particle diameter of the particles, the dispersion medium, the dispersion method and the content of the particles in the resin particle dispersion, the same is applied to the colorant particles dispersed in the colorant particle dispersion and the release agent particles dispersed in the release agent particle dispersion.

Aggregated Particle Forming Process

Next, along with the resin particle dispersion, the colorant particle dispersion and the release agent particle dispersion are mixed.

Then, in the mixed dispersion, the resin particles, the colorant particles and the release agent particles are heteroaggregated to form aggregated particles containing the resin particles, the colorant particles and the release agent particles, which have an approximately targeted particle diameter of the toner particle.

Specifically, for example, an aggregation agent is added to the mixed dispersion, and the pH of the mixed dispersion is adjusted to an acidic range (for example, from pH 2 to 5). If necessary, a dispersion stabilizer is added thereto, followed by heating to the glass transition temperature of the resin particles (specifically, for example, from the glass transition temperature of the resin particles—30° C. to the glass transition temperature—10° C.). The particles dispersed in the mixed dispersion are aggregated to form aggregated particles.

In the aggregated particle forming process, for example, the aggregation agent is added to the mixed dispersion while stirring using a rotary shear type homogenizer at room temperature (for example, 25° C.), and the pH of the mixed dispersion is adjusted to an acidic range (for example, from pH 2 to 5). If necessary, a dispersion stabilizer may be added thereto, followed by heating.

Examples of the aggregation agent include a surfactant having a polarity opposite to the polarity of the surfactant used as the dispersant which is added to the mixed dispersion, for example, an inorganic metal salt and a divalent or higher-valent metal complex. Particularly, in the case in which a metal complex is used as an aggregation agent, the amount of the surfactant used is reduced, which results in improvement of charging properties.

An additive capable of forming a complex or a similar bond with a metal ion in the aggregation agent may be used if necessary. As the additive, a chelating agent is suitably used.

Examples of the inorganic metal salt include metal salts such as calcium chloride, calcium nitrate, barium chloride, magnesium chloride, zinc chloride, aluminum chloride and aluminum sulfate, and polymers of inorganic metal salts such as polyaluminum chloride, polyaluminum hydroxide and calcium polysulfide.

The chelating agent may be a water soluble chelating agent. Examples of the chelating agent include oxycarboxylic acids such as tartaric acid, citric acid and gluconic acid, iminodiacetic acid (IDA), nitrilotriacetic acid (NTA), and ethylenediaminetetraacetic acid (EDTA).

The amount of the chelating agent added is preferably from 0.01 parts by weight to 5.0 parts by weight and more preferably 0.1 parts by weight or more and less than 3.0 parts by weight with respect to 100 parts by weight of the resin particles.

Further, in a system containing a release agent, since the distance between colorant particles becomes smaller due to the domain of the release agent, the coloring power is degraded.

In order to precisely control the dispersibility of a colorant in toner particles, it is desired to use a method of using a power feed addition method at the time of performing a process of forming aggregated particles according to the aggregation and coalescence method. The power feed addition method is a method of, for example, dividing a liquid to be added into two containers A and B and adding the liquid in the container A dropwise to a reaction system while adding the liquid of the container B dropwise to the container A. By suitably adjusting the timing of dropwise addition and the speed thereof using the liquid in the container A as a resin particle dispersion and the liquid in the container B as a colorant particle dispersion according to this method, the concentration of the colorant in toner particles may be controlled with high precision.

In a case of preparing a magenta toner including a release agent, it is preferable that the release agent dispersion and a colorant particle dispersion during the aggregated particle forming process are added according to the power feed addition method.

Specifically, the colorant particle dispersion is continuously added at a predetermined timing until the content of added materials (here, the amount of “materials” indicate the total amount of a resin and a colorant (including a release agent in a case of using a release agent)) reaches 90% by weight from 0% by weight.

Meanwhile, it is preferable that the release agent dispersion begins to be added at the timing when the content of added materials reaches 75% by weight and the addition is finished until the content thereof reaches 90% by weight.

According to such a power feed addition method, toner particles which have a see-island structure having a see portion that includes a binder resin; and an island portion that includes a release agent and which have colorant particles with improved dispersibility because the influence of the island portion (release agent domain) including a release agent is reduced may be prepared. When the toner particles include magenta colorant particles with high dispersibility, magenta toner particles exhibiting the specific absorption spectrum of the present exemplary embodiment may be easily obtained.

Coalescing Process

Next, the aggregated particles are coalesced by heating the aggregated particle dispersion having the aggregated particles dispersed therein to, for example, the glass transition temperature of the resin particles (for example, 10° C. to 30° C. higher than the glass transition temperature of the resin particles) or higher, to form toner particles.

The toner particles are obtained by the above-described processes.

Further, the toner particles may be prepared by a process of forming second aggregated particles by obtaining an aggregated particle dispersion having the aggregated particles dispersed therein, mixing the aggregated particle dispersion and the resin particle dispersion having the resin particles dispersed therein and further carrying out aggregation so as to attach the resin particles on the surface of the aggregated particles, and a process of coalescing the second aggregated particles by heating a second aggregated particle dispersion having the second aggregated particles dispersed therein to form toner particles having a core and shell structure.

After the coalescing process is completed, the toner particles formed in the solution are subjected to known washing, solid-liquid separation and drying processes to obtain dried toner particles.

The washing process is preferably carried out by a sufficient replacement washing with ion exchange water from the viewpoint of charging properties. The solid-liquid separation process is not particularly limited, but it is preferable that the process is carried out by filtration under suction or pressure from the viewpoint of productivity. The drying process is not particularly limited but is preferably carried out by freeze-drying, flash jet drying, fluidized drying or vibration fluidized drying from the viewpoint of productivity.

The toner according to the exemplary embodiment is prepared by, for example, adding an external additive to the obtained dried toner particles, and mixing the materials. The mixing is preferably carried out using, for example, a V blender, a HENSCHEL mixer, a LÖDIGE mixer and the like. Further, if necessary, coarse particles of the toner are preferably removed using a vibration sieve or a wind classifier.

Electrostatic Charge Image Developer

An electrostatic charge image developer of the present exemplary embodiment contains at least the magenta toner according to the present exemplary embodiment.

The electrostatic charge image developer according to the present exemplary embodiment may be a single-component developer containing only the magenta toner according to the present exemplary embodiment or may be a two-component developer obtained by mixing the toner and a carrier.

The carrier is not particularly limited and known carriers may be exemplified. Examples of the carrier include a coated carrier in which the surface of a core material made of magnetic powder is coated with a coating resin; a magnetic powder dispersion type carrier in which magnetic powder is dispersed and combined with a matrix resin; a resin impregnation type carrier in which porous magnetic powder is impregnated with a resin.

Further, the magnetic powder dispersion type carrier, the resin impregnation type carrier, and the conductive particle dispersion type carrier may be carriers using constituent particles of the carrier as the core material and coated with a coating resin.

Examples of the magnetic powder include magnetic metals such as iron, nickel, and cobalt; and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl-chloride-vinyl acetate copolymer, a styrene-acrylic acid copolymer, a straight silicone resin having an organosiloxane bond or a modified product thereof, a fluorine resin, polyester, polycarbonate, a phenol resin, and an epoxy resin.

Further, other additives such as conductive particles may be contained in the coating resin and the matrix resin.

Examples of the conductive particles include particles of metals such as gold, silver, and copper, carbon black, titanium oxide, zinc oxide, tin oxide, barium sulfate, aluminum borate, and potassium titanate.

Examples of the method of coating the surface of a core material with a coating resin include a method of coating the surface thereof with a coating resin or a solution for forming a coating layer obtained by dissolving various additives in an appropriate solvent according to the necessity. The solvent is not particularly limited and may be selected in consideration of a coating resin to be used, coating suitability, and the like.

Specific examples of the method of coating the surface with a resin include an immersion method of immersing a core material in a solution for forming a coating layer; a spray method of spraying a solution for forming a coating layer to the surface of a core material; a fluidized bed method of spraying a solution for forming a coating layer in a state in which a core material is floated due to fluidized air; and a kneader coater method of mixing core material of the carrier with a solution for forming a coating layer in a kneader coater and removing the solvent.

The mixing ratio (weight ratio) of the toner to the carrier (toner:carrier) in the two-component developer is preferably in the range of 1:100 to 30:100 and more preferably in the range of 3:100 to 20:100.

Electrostatic Charge Image Developing Toner Set

An electrostatic charge image developing toner set (hereinafter, also simply referred to as a “toner set”) according to the present exemplary embodiment includes an electrostatic charge image developing yellow toner and the above-described electrostatic charge image developing magenta toner according to the present exemplary embodiment.

It is preferable that the yellow toner constituting the electrostatic charge image developing toner set according to the present exemplary embodiment has an maximum absorption wavelength λmax (Y) of 400 nm to 440 nm at a wavelength of 360 nm to 760 nm and the absorbance at a wavelength of 510 nm is 0.20 or less and the absorbance at a wavelength of 550 nm is 0.10 or less when the absorbance of the maximum absorption wavelength λmax (Y) is standardized to 1. Further, it is preferable that the full width at half maximum of the absorption peak in the maximum absorption wavelength λmax (Y) of the yellow toner is 50 nm or less.

In a case where a red color image obtained as a secondary color using a combination of such as yellow toner and the magenta toner according to the present exemplary embodiment is formed, a change in color tone of the red color image in a state of being exposed to sunlight for a long period of time is prevented. The reason thereof is assumed as follows.

The absorbance of the long wavelength side of the yellow colorant is prevented while securing the coloring of yellow by combining the magenta toner with the yellow toner exhibiting the above-described absorption spectrum. Therefore, it is assumed that a change in color tone is further prevented since the light absorption amount at a wavelength of 450 nm to 600 nm resulting from the yellow toner is small and the extent of a decrease in absorbance at a wavelength of 450 nm to 600 nm is small even when the yellow colorant is degraded due to sunlight in the red color image formed by combining the magenta toner according to the present exemplary embodiment and the yellow toner exhibiting the absorption spectrum.

The yellow toner according to the present exemplary embodiment includes yellow toner particle and, if necessary, external additives.

Yellow Toner Particles

The yellow toner particles according to the present exemplary embodiment may include a binder resin, a yellow colorant as a colorant, and if necessary, a release agent or other additives.

The binder resin, the release agent, and other additives constituting the yellow toner particles are the same as those of the above-described magenta toner particles, and the description thereof will not be repeated.

Colorant

A colorant included in the yellow toner particles according to the present exemplary embodiment is not particularly limited as long as the yellow toner according to the present exemplary embodiment is a colorant which has a maximum absorption wavelength λmax (Y) of 400 nm to 440 nm at a wavelength of 360 nm to 760 nm and in which the absorbance at a wavelength of 510 nm is 0.20 or less and the absorbance at a wavelength of 550 nm is 0.10 or less when the absorbance of the maximum absorption wavelength λmax (Y) is standardized to 1.

As the colorant included in the yellow toner particles according to the present exemplary embodiment, Pigment Yellow 74 may be preferably used.

Moreover, the yellow toner according to the present exemplary embodiment may include another colorant without limiting to Pigment Yellow 74 when the maximum absorption wavelength λmax (Y) of the toner, the standardized absorbance at a wavelength of 510 nm, and the standardized absorbance at a wavelength of 550 nm are respectively in the above-described ranges. However, Pigment Yellow 74 is preferable and the content of another colorant is preferably 10% by weight or less and more preferably 5% by weight or less with respect to the total content of colorants. Further, it is still more preferable that another colorant is not used.

As C.I. Pigment Yellow 74 in which the maximum absorption wavelength, the standardized absorbance at a wavelength of 510 nm, and the standardized absorbance at a wavelength of 550 nm are respectively in the above-described ranges, commercially available C.I.Pigment Yellow 74 subjected to a treatment according to a specific treatment method described below may be exemplified.

A method of dispersing C.I.Pigment Yellow 74 in an aqueous dispersion medium including a surfactant, performing separation using a centrifugal separator to collect the supernatant thereof may be exemplified as the specific treatment method. C.I.Pigment Yellow 74 in which the maximum absorption wavelength, the standardized absorbance at a wavelength of 510 nm, and the standardized absorbance at a wavelength of 550 nm are respectively in the above-described ranges is obtained from the supernatant.

As the aqueous dispersion medium and the surfactant used for the specific treatment method, those which are the same used for preparing a typical colorant particle dispersion may be used.

Examples of the aqueous dispersion medium include water such as distilled water or ion exchange water, and alcohols. These may be used alone or in combination of two or more kinds thereof.

Examples of the surfactant include anionic surfactants such as sulfuric ester salts, sulfonates, phosphoric esters and soap surfactants; cationic surfactants such as amine salts and quaternary ammonium salts; and nonionic surfactants such as polyethylene glycol, alkylphenol ethylene oxide adducts and polyols. Among these, particularly, anionic surfactants and cationic surfactants are preferable. The nonionic surfactants may be used in combination with anionic surfactants or cationic surfactants.

The surfactants may be used alone or in combination of two or more kinds thereof.

The amount of the surfactant to be added may be in a range of 1 part by weight to 80 parts by weight, is preferably from 5 parts by weight to 50 parts by weight, and more preferably from 10 parts by weight to 30 parts by weight with respect to 100 parts by weight of C.I.Pigment Yellow 74.

As the method of dispersing C.I.Pigment Yellow 74 in an aqueous dispersion medium using a specific treatment method, dispersion methods using a rotary shear type homogenizer, a high pressure impact type disperser, a ball mill, a sand mill, or a DYNO mill having media may be exemplified. Further, these methods may be used in combination.

In this case, from the viewpoint that the maximum absorption wavelength λmax (Y) of a toner is set to be in the above-described range, it is preferable that C.I.Pigment Yellow 74 is dispersed in an aqueous dispersion medium according to the same method as that for preparing a typical colorant particle dispersion and then further treated using a high pressure impact type disperser. The pressure during the treatment carried out using a high pressure impact type disperser may be from 200 MPa to 300 MPa, and the number of passes may be in a range of 5 to 50.

Further, the separation using a centrifugal separator may be performed under the conditions of a gravity acceleration of 3×10⁴ G to 5×10⁶ G for a centrifugation time of 10 minutes to 600 minutes.

The volume average particle diameter of Pigment Yellow 74 treated by the specific treatment method may be from 70 nm to 300 nm, is preferably in a range of 80 nm to 200 nm, and more preferably from 100 nm to 150 nm.

The volume average particle diameter of C.I.Pigment Yellow 74 is measured using the particle size distribution measured by a laser diffraction particle size distribution measuring device (LA-700, manufactured by Horiba, Ltd.), a cumulative distribution is drawn from the small diameter side with respect to the volume based on the divided particle diameter ranges (channels), and the particle diameter at which the cumulative volume distribution reaches 50% of the total particle volume is defined as a volume average particle diameter D50v. Hereinafter, the volume average particle diameter of particles in the other dispersion will be measured in the same manner. With a measurement sample, particle size distribution is calculated by setting an input value of the refractive index of a dispersion medium as 1.333 and setting an input value of the refractive index of particles (C.I.Pigment Yellow 74) as 1.590 using a dispersion in which C.I.Pigment Yellow 74 is dispersed in the aqueous dispersion medium as a measurement sample.

The specific weight of C.I.Pigment Yellow 74 treated by the specific treatment method may be from 1.00 to 1.30, is preferably from 1.00 to 1.20, and more preferably from 1.00 to 1.10.

Further, the specific weight thereof is measured using a specific weight measuring kit AD1653 (manufactured by A & D Company, Ltd.).

D84v/D50v of Pigment Yellow 74 treated by the specific treatment method may be from 1.00 to 2.00 and is preferably in a range of 1.00 to 1.70.

Further, D84v/D50v described above is determined from values obtained by measuring the volume average particle diameter of C. I. Pigment Yellow 74. Specifically, a cumulative distribution is drawn from the small diameter side with respect to the volume based on the divided particle size ranges (channels), the particle diameter at which the cumulative volume distribution reaches 84% of the total particle volume is defined as “D84v”, and the particle diameter at which the cumulative volume distribution reaches 50% of the total particle volume is defined as “D50v”, and then the value of “D84v/D50v” is determined.

The content of the colorant is, for example, preferably from 1% by weight to 30% by weight and more preferably from 3% by weight to 15% by weight with respect to the entire yellow toner particles.

Electrostatic Charge Image Developer Set

An electrostatic charge image developer set of the present exemplary embodiment includes a first electrostatic charge image developer having a yellow toner of the toner set according to the present exemplary embodiment and a second electrostatic charge image developer having a magenta toner of the toner set according to the present exemplary embodiment.

Each electrostatic charge image developers may be a single-component developer containing only a toner or may be a two-component developer obtained by mixing the toner and a carrier.

The contents of the carrier are the same as in the above-described developer including the magenta toner particles, and the description thereof will not be repeated here.

Image Forming Apparatus/Image Forming Method

An image forming apparatus and an image forming method according to the present exemplary embodiment will be described.

The image forming apparatus according to the present exemplary embodiment includes an image holding member; a charging unit that charges the surface of the image holding member; an electrostatic charge image forming unit that forms an electrostatic charge image on the surface of the charged image holding member; a developing unit that contains an electrostatic charge image developer and develops the electrostatic charge image formed on the surface of the image holding member as a toner image using the electrostatic charge image developer; a transfer unit that transfers the toner image formed on the surface of the image holding member to the surface of a recording medium; and a fixing unit that fixes the toner image transferred to the surface of the recording medium. In addition, the electrostatic charge image developer according to the present exemplary embodiment is applied as an electrostatic charge image developer.

In the image forming apparatus according to the present exemplary embodiment, an image forming method (image forming method according to the present exemplary embodiment) including a charging process of charging the surface of the image holding member; an electrostatic charge image forming process of forming an electrostatic charge image on the surface of the charged image holding member; a developing process of developing the electrostatic charge image formed on the surface of the image holding member as a toner image using the electrostatic charge image developer according to the present exemplary embodiment; a transfer process of transferring the toner image formed on the surface of the image holding member to the surface of a recording medium; and a fixing process of fixing the toner image transferred to the surface of the recording medium is performed.

As the image forming apparatus according to the exemplary embodiment, well-known image forming apparatuses such as a direct transfer type image forming apparatus which directly transfers a toner image formed on the surface of an image holding member onto a recording medium; an intermediate transfer type image forming apparatus which primarily transfers a toner image formed on the surface of an image holding member onto the surface of an intermediate transfer member and secondarily transfers the toner image transferred on the surface of the intermediate transfer member onto the surface of a recording medium; an image forming apparatus including a cleaning unit which cleans the surface of an image holding member before charged and after a toner image is transferred; and an image forming apparatus including an erasing unit which erases a charge from the surface of an image holding member before charged and after a toner image is transferred, by irradiating the surface with easing light may be used.

In the case of an intermediate transfer type image forming apparatus, a transfer unit is configured to have, for example, an intermediate transfer member having a surface to which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to this exemplary embodiment, for example, a part including the developing unit may have a cartridge structure (process cartridge) that is detachable from the image forming apparatus. As the process cartridge, for example, a process cartridge that contains the electrostatic charge image developer according to the exemplary embodiment and is provided with a developing unit is suitably used.

Hereinafter, an example of the image forming apparatus according to this exemplary embodiment will be shown. However, the image forming apparatus is not limited thereto. Main parts shown in the drawing will be described, but descriptions of other parts will not be repeated.

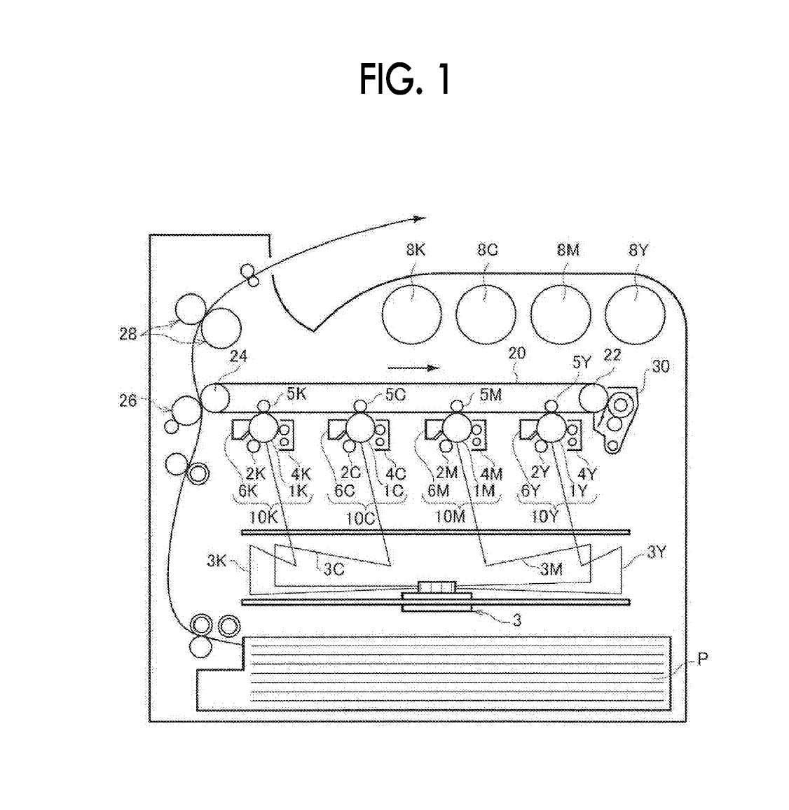

FIG. 1 is a schematic configuration view showing an image forming apparatus according to the exemplary embodiment.

The image forming apparatus shown in FIG. 1 includes first to fourth electrophotographic image forming units (image forming units) 10Y, 10M, 10C, and 10K which output images of the respective colors including yellow (Y), magenta (M), cyan (C), and black (K) according to color-separated image data. These image forming units (hereinafter, also referred to simply as “units” in some cases) 10Y, 10M, 10C and 10K are disposed horizontally in a line with predetermined distances therebetween. Incidentally, each of these units 10Y, 10M, 10C and 10K may be a process cartridge which is detachable from the image forming apparatus.

An intermediate transfer belt 20 is provided through each unit as an intermediate transfer member extending above each of the units 10Y, 10M, 10C and 10K in the drawing. The intermediate transfer belt 20 is provided around a drive roller 22 and a support roller 24 which contacts with the inner surface of the intermediate transfer belt 20, which are disposed to be separated from each other from left to right in the drawing. The intermediate transfer belt 20 travels in a direction from the first unit 10Y to the fourth unit 10K. Incidentally, the support roller 24 is pushed in a direction away from the drive roller 22 by a spring or the like (not shown), such that tension is applied to the intermediate transfer belt 20 which is provided around the support roller 24 and the drive roller 22. Also, on the surface of the image holding member side of the intermediate transfer belt 20, an intermediate transfer member cleaning device 30 is provided to face the drive roller 22.

In addition, toners including toners of four colors of yellow, magenta, cyan and black, which are contained in toner cartridges 8Y, 8M, 8C and 8K, respectively, are supplied to developing devices (developing units) 4Y, 4M, 4C and 4K of each of the units 10Y, 10M, 10C and 10K, respectively.

Since the first to fourth units 10Y, 10M, 10C, and 10K have the same configuration, the first unit 10Y, which is provided on the upstream side in the travelling direction of the intermediate transfer belt and forms a yellow image, will be described as a representative example. In addition, the same components as those of the first unit 10Y are represented by reference numerals to which the symbols M (magenta), C (cyan), and K (black) are attached instead of the symbol Y (yellow), and the descriptions of the second to fourth units 10M, 10C, and 10K, will not be repeated.

The first unit 10Y includes a photoreceptor 1Y functioning as the image holding member. In the vicinity of the photoreceptor 1Y, a charging roller 2Y (an example of the charging unit) for charging the surface of the photoreceptor 1Y to a predetermined potential, an exposure device 3 (an example of the electrostatic charge image forming unit) for exposing the charged surface to a laser beam 3Y based on a color-separated image signal to form an electrostatic charge image, the developing device 4Y (an example of the developing unit) for supplying a charged toner into the electrostatic charge image to develop the electrostatic charge image, a primary transfer roller 5Y (an example of the primary transfer unit) for transferring the developed toner image onto the intermediate transfer belt 20, and a photoreceptor cleaning device 6Y (an example of the cleaning unit) for removing the toner remaining on the surface of the photoreceptor 1Y after the primary transfer are disposed in this order.

The primary transfer roller 5Y is disposed inside the intermediate transfer belt 20 and provided opposite to the photoreceptor 1Y. Furthermore, bias power supplies (not shown), which apply primary transfer biases, are respectively connected to the respective primary transfer rollers 5Y, 5M, 5C and 5K. A controller (not shown) controls the respective bias power supplies to change the transfer biases which are applied to the respective primary transfer rollers.

Hereinafter, the operation of forming a yellow image in the first unit 10Y will be described.

First, before the operation, the surface of the photoreceptor 1Y is charged to a potential of −600 V to −800 V by the charging roller 2Y.

The photoreceptor 1Y is formed by stacking a photosensitive layer on a conductive substrate (for example, volume resistivity at 20° C.: 1×10⁻⁶ Ωcm or lower). In general, the photosensitive layer has high resistance (resistance similar to that of general resin), but has properties in which, when irradiated with the laser beam 3Y, the specific resistance of a portion irradiated with the laser beam changes. Thus, the laser beam 3Y is output to the charged surface of the photoreceptor 1Y through the exposure device 3 in accordance with yellow image data sent from the controller (not shown). The photosensitive layer on the surface of the photoreceptor 1Y is irradiated with the laser beam 3Y. As a result, an electrostatic charge image having a yellow image pattern is formed on the surface of the photoreceptor 1Y.

The electrostatic charge image is an image which is formed on the surface of the photoreceptor 1Y by charging and is a so-called negative latent image which is formed when the specific resistance of a portion, which is irradiated with the laser beam 3Y, of the photosensitive layer is reduced and the charge flows on the surface of the photoreceptor 1Y and, in contrast, when the charge remains in a portion which is not irradiated with the laser beam 3Y as a toner image.

The electrostatic charge image formed on the surface of the photoreceptor 1Y is rotated to a predetermined development position along with the travel of the photoreceptor 1Y. At this development position, the electrostatic charge image on the photoreceptor 1Y is visualized (developed) by the developing device 4Y.

The developing device 4Y contains, for example, an electrostatic charge image developer containing at least a yellow toner and a carrier. The yellow toner is frictionally charged by being stirred in the developing device 4Y to have a charge with the same polarity (negative polarity) as that of a charge on the photoreceptor 1Y and is maintained on a developer roller (an example of the developer holding member). When the surface of the photoreceptor 1Y passes through the developing device 4Y, the yellow toner is electrostatically attached to a latent image portion on the surface of the photoreceptor 1Y from which the charge is erased, and the latent image is developed with the yellow toner. The photoreceptor 1Y on which a yellow toner image is formed subsequently travels at a predetermined rate, and the toner image developed on the photoreceptor 1Y is transported to a predetermined primary transfer position.

When the yellow toner image on the photoreceptor 1Y is transported to the primary transfer position, a primary transfer bias is applied to the primary transfer roller 5Y, an electrostatic force directed from the photoreceptor 1Y toward the primary transfer roller 5Y acts upon the toner image, and the toner image on the photoreceptor 1Y is transferred onto the intermediate transfer belt 20. The transfer bias applied at this time has a (+) polarity opposite to the polarity (−) of the toner. For example, the first unit 10Y is controlled to +10 μA by the controller (not shown).

On the other hand, the toner remaining on the photoreceptor 1Y is removed and collected by the photoreceptor cleaning device 6Y.

Also, primary transfer biases to be applied respectively to the primary transfer rollers 5M, 5C and 5K of the second unit 10M and subsequent units are controlled similarly to the primary transfer bias of the first unit.

In this manner, the intermediate transfer belt 20 having a yellow toner image transferred thereonto in the first unit 10Y is sequentially transported through the second to fourth units 10M, 10C and 10K, and toner images of respective colors are superposed and multi-transferred.

The intermediate transfer belt 20 having the four toner images multi-transferred thereonto through the first to fourth units arrives at a secondary transfer portion which is configured with the intermediate transfer belt 20, the support roller 24 which contacts with the inner surface of the intermediate transfer belt and a secondary transfer roller 26 (an example of the secondary transfer unit) disposed on the side of the image holding surface of the intermediate transfer belt 20. Meanwhile, a recording sheet P (an example of the recording medium) is supplied to a gap at which the secondary transfer roller 26 and the intermediate transfer belt 20 contact with each other at a predetermined timing through a supply mechanism and a secondary transfer bias is applied to the support roller 24. The transfer bias applied at this time has the same (−) polarity as the polarity (−) of the toner, and an electrostatic force directing from the intermediate transfer belt 20 toward the recording sheet P acts upon the toner image, so that the toner image on the intermediate transfer belt 20 is transferred onto the recording sheet P. Incidentally, at this time, the secondary transfer bias is determined according to the resistance detected by a resistance detecting unit (not shown) for detecting a resistance of the secondary transfer portion, and the voltage is controlled.

Then, the recording sheet P is sent to a press contact portion (nip portion) of a pair of fixing rollers in a fixing device 28 (an example of the fixing unit), and the sent toner image is fixed onto the recording sheet P to forma fixed image.

Examples of the recording sheet P onto which the toner image is transferred include plain paper used for electrophotographic copying machines, printers and the like. As the recording medium, other than the recording sheet P, OHP sheets may be used.

In order to improve the smoothness of the image surface after the fixing, the surface of the recording sheet P is preferably smooth, and for example, coated paper in which the surface of plain paper is coated with a resin and the like, art paper for printing and the like are suitably used.

The recording sheet P in which fixing of a color image is completed is transported to an ejection portion, and a series of the color image formation operations is completed.

The image forming apparatus according to the present exemplary embodiment includes a first image forming unit that forms a yellow toner image using a yellow toner of the toner set according to the present exemplary embodiment; a second image forming unit that forms a magenta toner image using the magenta toner of the toner set according to the present exemplary embodiment; a transfer unit that transfers the yellow toner image and the magenta toner image onto the recording medium; and a fixing unit that fixes the yellow toner image and the magenta toner image to the recording medium.

The image forming apparatus according to the present exemplary embodiment may include respective image forming units, as the first image forming unit and the second image forming unit, that respectively include an image holding member, a charging unit that charges the surface of the image holding member, an electrostatic charge image forming unit that forms an electrostatic charge image on the surface of the charged image holding member, and a developing unit that develops the electrostatic charge image formed on the surface of the image holding member as a toner image using the electrostatic charge image developer.

Further, the image forming apparatus according to the present exemplary embodiment may include an image holding member, a charging unit that charges the surface of the image holding member, an electrostatic charge image forming unit that forms an electrostatic charge image on the surface of the charged image holding member, and a first developing unit and a second developing unit that develop the form electrostatic charge image on the surface of the image holding member as a toner image using an electrostatic charge image developer, as the first image forming unit and the second image forming unit.

In the image forming apparatus according to the present exemplary embodiment, an image forming method (the image forming method according to the present exemplary embodiment) that includes a first image forming process of forming a yellow toner image using a yellow toner of the toner set according to the present exemplary embodiment; a second image forming process of forming a magenta toner image using the magenta toner of the toner set according to the present exemplary embodiment; a transfer process of transferring the yellow toner image and the magenta toner image onto the recording medium; and a fixing process of fixing the yellow toner image and the magenta toner image to the recording medium is performed.

As the image forming apparatus according to the exemplary embodiment, well-known image forming apparatuses such as a direct transfer type image forming apparatus which directly transfers a toner image formed on the surface of an image holding member onto a recording medium; an intermediate transfer type image forming apparatus which primarily transfers a toner image formed on the surface of an image holding member onto the surface of an intermediate transfer member and secondarily transfers the toner image transferred on the surface of the intermediate transfer member onto the surface of a recording medium; an image forming apparatus including a cleaning unit which cleans the surface of an image holding member before charged and after a toner image is transferred; and an image forming apparatus including an erasing unit which erases a charge from the surface of an image holding member before charged and after a toner image is transferred, by irradiating the surface with easing light may be used.

In the case of an intermediate transfer type image forming apparatus, a transfer unit is configured to have, for example, an intermediate transfer member having a surface to which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

Process Cartridge and Toner Cartridge

A process cartridge according to the exemplary embodiment will be described.

The process cartridge according to the exemplary embodiment includes a developing unit, which contains the electrostatic charge image developer according to the exemplary embodiment and develops an electrostatic charge image formed on the surface of an image holding member as a toner image with the electrostatic charge image developer, and is detachable from the image forming apparatus.

In addition, the configuration of the process cartridge according to the exemplary embodiment is not limited thereto and may include a developing device and, additionally, at least one selected from other units such as an image holding member, a charging unit, an electrostatic charge image forming unit and a transfer unit, if necessary.

Hereinafter, an example of the process cartridge according to the exemplary embodiment will be shown and the process cartridge is not limited thereto. Main parts shown in the drawing will be described and the descriptions of other parts will not be repeated.

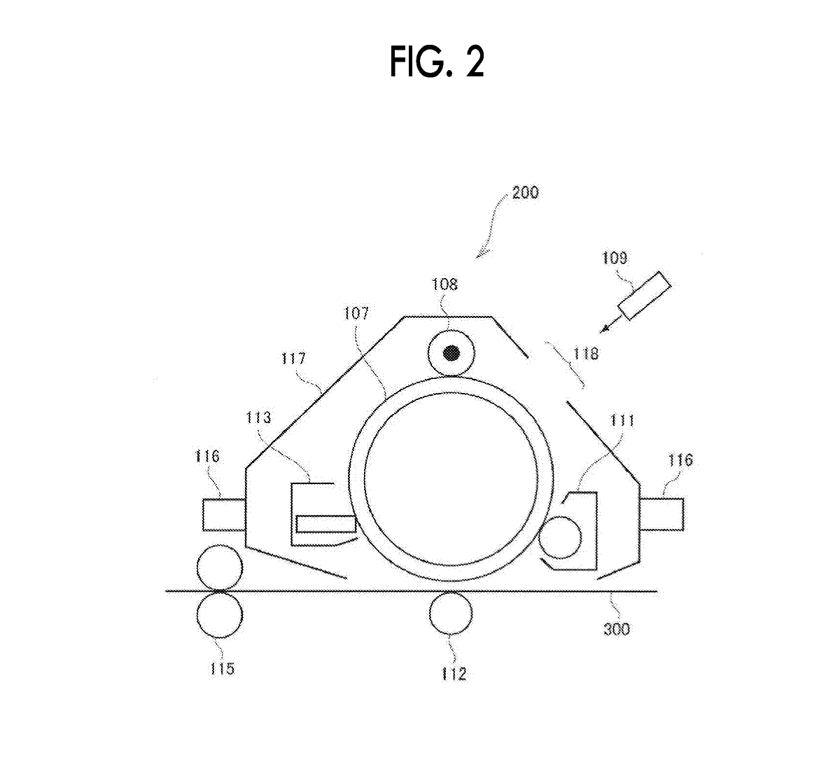

FIG. 2 is a schematic configuration view showing a process cartridge according to the present exemplary embodiment.

A process cartridge 200 shown in FIG. 2 includes, a photoreceptor 107 (an example of the image holding member), a charging roller 108 (an example of the charging unit) provided in the periphery of the photoreceptor 107, a developing device 111 (an example of the developing unit) and a photoreceptor cleaning device 113 (an example of the cleaning unit), all of which are integrally combined and supported, for example, by a housing 117 provided with a mounting rail 116 and an opening portion 118 for exposure to form a cartridge.

Then, in FIG. 2, 109 denotes an exposure device (an example of the electrostatic charge image forming unit), 112 denotes a transfer device (an example of the transfer unit), 115 denotes a fixing device (an example of the fixing unit), and 300 denotes a recording sheet (an example of the recording medium).

Next, a toner cartridge according to the exemplary embodiment will be described.

The toner cartridge according to the exemplary embodiment is a toner cartridge which contains the toner according to the exemplary embodiment therein and is detachable from the image forming apparatus. The toner cartridge contains the toner for replenishment in order to supply the toner to the developing unit provided in the image forming apparatus. The toner cartridge according to the exemplary embodiment may have a container which contains the toner according to the exemplary embodiment.

The image forming apparatus shown in FIG. 1 is an image forming apparatus having a configuration in which the toner cartridges 8Y, 8M, 8C and 8K are detachable, and the developing devices 4Y, 4M, 4C, and 4K are connected to toner cartridges corresponding to the respective developing devices (colors) via a toner supply pipe (not shown). Also, in the case where the toner contained in the toner cartridge runs low, the toner cartridge is replaced.

The image forming apparatus according to the present exemplary embodiment may include a toner cartridge set that includes a first toner cartridge that contains a yellow toner of the toner set according to the present exemplary embodiment and a second toner cartridge that contains a magenta toner of the toner set according to the present exemplary embodiment and is detachable from the image forming apparatus.

The image forming apparatus according to the present exemplary embodiment may further include a process cartridge that includes a first developing unit that contains the first electrostatic charge image developer of the electrostatic charge image developer set according to the present exemplary embodiment and a second developing unit that contains the second electrostatic charge image developer of the electrostatic charge image developer set according to the present exemplary embodiment and is detachable from the image forming apparatus.

Hereinbefore, the magenta toner including the magenta colorant and the yellow toner including the yellow colorant have been described, but the toner according to the present exemplary embodiment may be an electrostatic charge image developing toner that includes a binder resin; a magenta colorant which has a maximum absorption wavelength λmax (M) of 530 nm to 580 nm at a wavelength of 360 nm to 760 nm and in which the absorbance at a wavelength of 450 nm is 0.20 or less and the absorbance at a wavelength of 400 nm is 0.10 or less when the absorbance of the maximum absorption wavelength λmax (M) is standardized to 1; and a yellow colorant which has a maximum absorption wavelength λmax (Y) of 400 nm to 440 nm at a wavelength of 360 nm to 760 nm and in which the absorbance at a wavelength of 510 nm is 0.20 or less and the absorbance at a wavelength of 550 nm is 0.10 or less when the absorbance of the maximum absorption wavelength λmax (Y) is standardized to 1.

Such an electrostatic charge image developing toner is a red toner exhibiting a red color. With only this toner, a red color image may be formed. A change in color tone, of this red color image forming such a red toner, when exposed to sunlight for a long period of time is also prevented.

### Examples

Hereinafter, the exemplary embodiment will be described in more detail based on examples but the exemplary embodiment is not limited to these examples. In the following description, unless specified otherwise, “part(s)” represents “part(s) by weight”.

Preparation of Colorant Particle Dispersion

Preparation of Colorant Particle Dispersion (M1)

As a magenta pigment, 20 parts by weight of C. I. Pigment Red 122, 2 parts by weight (10% by weight with respect to a colorant as an effective component) of an anionic surfactant (NEOGEN SC, manufactured by Dai-ichi Kogyo Seiyaku Co., Ltd.), and 78 parts by weight of ion exchange water are mixed with each other and dispersed at 6000 rpm for 5 minutes using a homogenizer (ULTRA-TURRAX T50, manufactured by IKA, Inc.).

Thereafter, the dispersion is defoamed by being stirred using a stirrer for one night and then uniformly dispersed at a pressure of 240 MPa using a high pressure impact type disperser ULTIMIZER (HJP30006, manufactured by SUGINO MACHINE LIMITED). The dispersion is performed through 20 passes. Next, the dispersed pigment is treated for separation at a gravity acceleration of 5.5×10⁴ G for 35 minutes using a centrifugal separator (HIMAC CR22G, manufactured by Hitachi Koki Co., Ltd.) and allowed to stand still for 25 minutes, and 30% by volume of the supernatant with respect to the entire volume is collected, thereby obtaining a colorant particle dispersion (M1).

The volume average particle diameter D50v of colorant particles of the colorant particle dispersion (M1) is 150 nm and D84v/D50v is 1.25.

Adjustment is made by adding ion exchange water such that the pigment concentration is 0.04 g/L. Further, when the absorption spectrum of the colorant particle dispersion (M1) is measured using a spectrophotometer (ULTRA SCAN PRO, manufactured by Hunter Associates Laboratory, Inc.), the maximum absorption wavelength is 573 nm, the full width at half width is 90 nm, the standardized absorbance at a wavelength of 450 nm is 0.18, and the standardized absorbance at a wavelength of 400 nm is 0.07.

Preparation of Colorant Particle Dispersion (M2)

A colorant particle dispersion (M2) is prepared in the same manner as in the preparation of the colorant particle dispersion (M1) except that dispersion is performed through 20 passes of a high pressure impact type disperser ULTIMIZER used for preparation of the colorant particle dispersion (M1) and the time for centrifugation is adjusted to 25 minutes.

Preparation of Colorant Particle Dispersion (M3)

A colorant particle dispersion (M3) is prepared in the same manner as in the preparation of the colorant particle dispersion (M1) except that dispersion is performed through 18 passes of a high pressure impact type disperser ULTIMIZER used for preparation of the colorant particle dispersion (M1) and the time for centrifugation is adjusted to 35 minutes.

Preparation of Colorant Particle Dispersion (M4)

A colorant particle dispersion (M4) is prepared in the same manner as in the preparation of the colorant particle dispersion (M1) except that dispersion is performed through 18 passes of a high pressure impact type disperser ULTIMIZER used for preparation of the colorant particle dispersion (M1) and the time for centrifugation is adjusted to 25 minutes.

Preparation of Colorant Particle Dispersion (M5)

A colorant particle dispersion (M5) is prepared in the same manner as in the preparation of the colorant particle dispersion (M1) except that dispersion is performed through 15 passes of a high pressure impact type disperser ULTIMIZER used for preparation of the colorant particle dispersion (M1) and the time for centrifugation is adjusted to 20 minutes.

Preparation of Colorant Particle Dispersion (M6)

A colorant particle dispersion (M6) is prepared in the same manner as in the preparation of the colorant particle dispersion (M1) except that dispersion is performed through 3 passes of a high pressure impact type disperser ULTIMIZER used for preparation of the colorant particle dispersion (M1) and the time for centrifugation is adjusted to 15 minutes.

Preparation of Colorant Particle Dispersion (M7)

A colorant particle dispersion (M7) is prepared in the same manner as in the preparation of the colorant particle dispersion (M1) except that dispersion is performed through 15 passes of a high pressure impact type disperser ULTIMIZER used for preparation of the colorant particle dispersion (M1) and the time for centrifugation is adjusted to 10 minutes.

Preparation of Colorant Particle Dispersion (M8)

A colorant particle dispersion (M8) is prepared in the same manner as in the preparation of the colorant particle dispersion (M1) except that dispersion is performed through 25 passes of a high pressure impact type disperser ULTIMIZER used for preparation of the colorant particle dispersion (M1) and the time for centrifugation is adjusted to 20 minutes.

Preparation of Colorant Particle Dispersion (M9)

A colorant particle dispersion (M9) is prepared in the same manner as in the preparation of the colorant particle dispersion (M1) except that dispersion is performed through 30 passes of a high pressure impact type disperser ULTIMIZER used for preparation of the colorant particle dispersion (M1) and the time for centrifugation is adjusted to 50 minutes.

Preparation of Colorant Particle Dispersion (M10)

A colorant particle dispersion (M10) is prepared in the same manner as in the preparation of the colorant particle dispersion (M1) except that dispersion is performed through 15 passes of a high pressure impact type disperser ULTIMIZER used for preparation of the colorant particle dispersion (M1) and the time for centrifugation is adjusted to 25 minutes.

Preparation of Colorant Particle Dispersion (M11)

A colorant particle dispersion (M11) is prepared in the same manner as in the preparation of the colorant particle dispersion (M1) except that dispersion is performed through 20 passes of a high pressure impact type disperser ULTIMIZER used for preparation of the colorant particle dispersion (M1) and the time for centrifugation is adjusted to 20 minutes.

Preparation of Resin Particle Dispersion (1)
Terephthalic acid: 30 parts by mole
Fumaric acid: 70 parts by mole
Bisphenol A ethylene oxide adduct: 5 parts by mole
Bisphenol A propylene oxide adduct: 95 parts by mole

The above-described materials are added to a flask provided with a stirrer, a nitrogen introduction pipe, a temperature sensor, and a rectifying column and having an amount of content of 5 L, the temperature thereof is increased to 220° C. for 1 hour, and 1 part of titanium tetraethoxide is added thereto with respect to 100 parts of the materials. The temperature thereof is increased to 230° C. for 0.5 hours while distilling off water being generated, a dehydration and condensation reaction is continued at the same temperature for 1 hour, and then the reactant is cooled. In this manner, a polyester resin (1) having a weight average molecular weight of 18,000, an acid value of 15 mgKOH/g, and a glass transition temperature of 60° C. is synthesized.

After 40 parts of ethyl acetate and 25 parts of 2-butanol are added to a container provided with a temperature adjustment unit and a nitrogen substitution unit to obtain a mixed solvent, 100 parts of the polyester resin (1) is gradually added thereto and dissolved therein, and a 10 weight % ammonia aqueous solution (amount equivalent to three times the acid value of a resin in terms of molar ratio) is added thereto, and then the solution is stirred for 30 minutes.

Subsequently, the inside of the container is substituted with dry nitrogen, the temperature therein is held at 40° C., and 400 parts of ion exchange water is added dropwise at a rate of 2 parts for one minute for emulsification. After dropwise addition, the emulsified solution is cooled to room temperature (20° C. to 25° C.) and stirred, bubbling is performed using dry nitrogen for 48 hours, and ethyl acetate and 2-butanol are reduced such that the content thereof becomes 1,000 ppm or less, thereby obtaining a resin particle dispersion in which resin particles having a volume average particle diameter of 200 nm are dispersed. Ion exchange water is added to the resin particle dispersion, and the solid content is adjusted to 20% by weight, thereby obtaining a resin particle dispersion (1).

When the volume average particle diameter D50v of the resin particle dispersion (1) is measured using a Doppler scattering type particle size distribution measuring device (MICROTRAC UPA9340, manufactured by Nikkiso Co., Ltd.), the value is 0.150 μm.

Preparation of Release Agent Particle Dispersion

Preparation of Release Agent Particle Dispersion (1)

| | | |
|---|---|---|
| Paraffin wax (HNP-9, manufactured by NIPPON SEIRO | 100 | parts |
| CO., LTD.) | | |
| Anionic surfactant (NEOGEN RK, manufactured by | 1 | part |
| Dai-ichi Kogyo Seiyaku Co., Ltd.) | | |
| Ion exchange water | 350 | parts |

The materials are mixed to each other, heated to 100° C., dispersed using a homogenizer (ULTRA-TURRAX T50, manufactured by IKA, Inc.), and subjected to a dispersion treatment using a Manton Gaulin high-pressure homogenizer (manufactured by Gaulin Corp.), thereby obtaining a release agent particle dispersion (1) in which release agent particles having a volume average particle diameter of 200 nm are dispersed (solid content of 20% by weight).

Preparation of Magenta Toner

Preparation of Magenta Toner (M1)

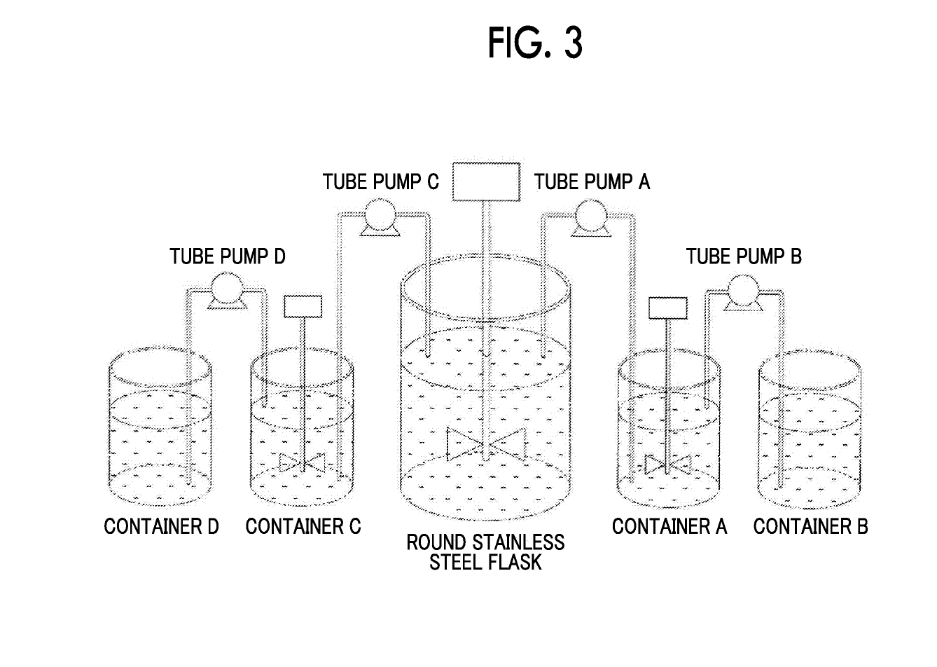

A device using a power feed addition method and shown in FIG. 3 is prepared. The device shown in FIG. 3 is operated according to a first power feed addition method on the right side on which a round stainless steel flask is provided and operated according to a second power feed addition method on the left side on which a round stainless steel flask is provided.

In the portion in which the first power feed addition method is performed, a round stainless steel flask and a container A are connected to each other through a tube pump A, the stored liquid stored in the container A is sent to a flask by driving the tube pump A, the container A and a container B are connected to each other through a tube pump B, the stored liquid stored in the container B is sent to the container A by driving the tube pump B.

In the portion in which the second power feed addition method is performed, a round stainless steel flask and a container C are connected to each other through a tube pump C, the stored liquid stored in the container C is sent to a flask by driving the tube pump C, the container C and a container D are connected to each other through a tube pump D, the stored liquid stored in the container D is sent to the container C by driving the tube pump D.

In the container A, the container C, and the round stainless steel flask, each stored liquid is stirred by a stirrer.

In addition, the following operations are performed using the device shown in FIG. 3.
Resin particle dispersion (1): 53.1 parts
Colorant particle dispersion (M1): 25 parts
Anionic surfactant (TAYCAPOWER): 2 parts

The above-described materials are put into a round stainless steel flask, 0.1 N of nitric acid is added thereto, and the pH thereof is adjusted to 3.5, and then 30 parts of a nitric acid aqueous solution having a polyaluminum chloride concentration of 10% by weight is added thereto. Next, the mixture is dispersed using a homogenizer (ULTRA-TURRAX T50, manufactured by IKA, Inc.) at 30° C., the temperature thereof is increased in an oil bath for heating at a pace of 1° C. for 30 minutes, and then the particle diameter of the first aggregated particles is grown.

12.5 parts of the release agent particle dispersion (2) is put into the container A which is a bottle made of polyester and 207.9 parts of resin particle dispersion (1) is put into the container B which is a bottle made of polyester.

Next, the liquid sending speed of the tube pump A is set to 3 parts/min, the liquid sending speed of the tube pump B is set to 6 parts/min, the temperature in the round stainless steel flask during formation of the first aggregated particles is increased at a rate of 1° C./min, the raising of the temperature is stopped at the time point when the particle diameter of the first aggregated particles becomes 2.9 μm, the tube pumps A and B are driven at the same time, and then each of the dispersions is sent.

Further, each of the dispersions is stirred for 30 minutes and held from the time point when the dispersions are completely sent to a flask, and then second aggregated particles are formed.

Next, 37.5 parts of the release agent particle dispersion (1) is put into the container C which is a bottle made of polyester and 164.0 parts of resin particle dispersion (1) is put into the container D which is a bottle made of polyester.

Subsequently, the liquid sending speed of the tube pump C is set to 9 parts/min, the liquid sending speed of the tube pump D is set to 6 parts/min, and the tube pumps C and D are driven at the same time, and then each of the dispersions is sent.

The temperature of each dispersion is increased by 1° C. and the dispersions are stirred for 30 minutes and held from the time point when the dispersions are completely sent to a flask, and then third aggregated particles are formed.

Thereafter, 0.1 N of a sodium hydroxide aqueous solution is added, the pH thereof is adjusted to 8.5, the solution is heated to 85° C. while being continuously stirred, and this state is held for 5 hours. Next, the solution is cooled to 20° C. at a rate of 20° C./min, filtered, sufficiently washed with ion exchange water, and dried, thereby obtaining magenta toner particles (M1) having a volume average particle diameter of 6.0 μm.

Preparation of Magenta Toners (M2) to (M8)

Magenta toner particles (M2) to (M8) and magenta toners (M2) to (M8) are obtained in the same manner as that of the magenta toner particles (M1) and the magenta toner (M1) except that colorant particle dispersions (M2) to (M8) are respectively used in place of the colorant particle dispersion (M1).

Preparation of Yellow Toner

Preparation of Colorant Particle Dispersion (Y1)

20 parts by weight of C. I. Pigment Yellow 74 (manufactured by Clariant Corp.), 2 parts by weight of an anionic surfactant (NEOGEN SC, manufactured by Dai-ichi Kogyo Seiyaku Co., Ltd.), and 78 parts by weight of ion exchange water are mixed with each other and dispersed at 6000 rpm for 5 minutes using a homogenizer (ULTRA-TURRAX T50, manufactured by IKA, Inc.). In this manner, a pre-colorant particle dispersion is obtained.

Thereafter, the dispersion is defoamed by being stirred using a stirrer for one night and then dispersed at a pressure of 240 MPa using a high pressure impact type disperser ULTIMIZER (HJP30006, manufactured by SUGINO MACHINE LIMITED). The dispersion is performed through 20 passes. Next, the resultant is treated for separation at a gravity acceleration of 5.5×10⁴ G for 35 minutes using a centrifugal separator (HIMAC CR22G, manufactured by Hitachi Koki Co., Ltd.) and allowed to standstill for 25 minutes, and 30% by volume of the supernatant with respect to the entire volume is collected, thereby obtaining a colorant particle dispersion (Y1).

The volume average particle diameter of colorant particles of the colorant particle dispersion (Y1) is 170 nm and D84v/D50v is 1.83.

Preparation of Colorant Particle Dispersion (Y2)

A colorant particle dispersion (Y2) is prepared in the same manner as in the preparation of the colorant particle dispersion (Y1) except that dispersion is performed through 25 passes of a high pressure impact type disperser ULTIMIZER used for preparation of the colorant particle dispersion (Y1) and the time for centrifugation is adjusted to 25 minutes.

The volume average particle diameter is 124 nm and D84v/D50v is 1.47.

Preparation of Yellow Toner (Y1)
Resin particle dispersion (1): 402.5 parts
Colorant particle dispersion (Y1): 22.5 parts
Release agent particle dispersion (1): 50 parts
Anionic surfactant (TAYCAPOWER): 2 parts

The above-described materials are put into a round stainless steel flask, 0.1 N of nitric acid is added thereto, and the pH thereof is adjusted to 3.5, and then 30 parts of a nitric acid aqueous solution having a polyaluminum chloride concentration of 10% by weight is added thereto. Next, the mixture is dispersed using a homogenizer (ULTRA-TURRAX T50, manufactured by IKA, Inc.) at 30° C., the solution is heated to 45° C. in an oil bath for heating, and this state is held for 30 minutes. Thereafter, 100 parts of the resin particle dispersion (1) is gradually added, this state is held for 1 hour, 0.1 N of a sodium hydroxide aqueous solution is added, the pH thereof is adjusted to 8.5, the solution is heated to 85° C. while being continuously stirred, and this state is held for 5 hours. Next, the solution is cooled to 20° C. at a rate of 20° C./min, filtered, sufficiently washed with ion exchange water, and dried, thereby obtaining yellow toner particles (Y1) having a volume average particle diameter of 7.5 μm.

100 parts of the yellow toner particles (Y1) and 0.7 parts of dimethyl silicone oil-treated silica particles (RY200, manufactured by Nippon Aerosil Co., Ltd.) are mixed with each other using a HENSCHEL mixer, thereby obtaining a yellow toner (Y1).

Preparation of Yellow Toner (Y2)

Yellow toner particles (Y2) and a yellow toner (Y2) are obtained in the same manner as that of the yellow toner particles (Y1) and the yellow toner (Y1) except that colorant particle dispersion (Y2) is respectively used in place of the colorant particle dispersion (Y1).

Preparation of Developer

| | | |
|---|---|---|
| Ferrite particles (average particle | 100 | parts by weight |
| diameter of 50 μm) | | |
| Toluene | 14 | parts by weight |
| Styrene-methyl methacrylate | 2 | parts |
| copolymer (component ratio: 15/85) | | |
| Carbon black | 0.2 | parts |

The above-described components other than the ferrite particles are dispersed in a sand mill, and the dispersion and ferrite particles are put into a vacuum degassing type kneader, decompressed and dried while being stirred, thereby preparing a carrier.

Further, toners respectively having a content of 5 parts with respect to 100 parts of the carrier are mixed with each other, thereby obtaining a developer.

Evaluation of Toner

Measurement of Absorption Spectrum

The maximum absorption wavelength Amax, the standardized absorbance at a specific wavelength, and the full width at half maximum of the obtained toners are measured according to the above-described method.

The maximum absorption wavelengths λmax (λmax (M) in the table), the standardized absorbance at a wavelength of 450 nm (“A₄₅₀” in the table), the standardized absorbance at a wavelength of 400 nm (“A₄₀₀” in the table), and the full width at half maximum (“FWHM” in the table) of respective magenta toners are listed in Table 1.

The maximum absorption wavelengths λmax (λmax (Y) in the table), the standardized absorbance at a wavelength of 510 nm (“A₅₁₀” in the table), the standardized absorbance at a wavelength of 550 nm (“A₅₅₀” in the table), and the full width at half maximum (“FWHM” in the table) of respective yellow toners are listed in Table 1.

The following processes, image formation, and measurement are performed in under the conditions of 25° C. and humidity of 60% RH.

DOCUCENTRE COLOR 400 (manufactured by Fuji Xerox Co., Ltd.) is prepared as an image forming apparatus that forms images for evaluation, and developers (developers including toners of the corresponding colors) obtained in the examples and comparative examples are put into a developing device. During the image formation, the fixing temperature is set to 190° C. and the fixing pressure is set to 4.0 kg/cm2. Coated paper (OS coated paper W, manufactured by Fuji Xerox Co., Ltd.) is used as a recording medium.

Evaluation of Change in Color Tone Due to Irradiation with Light

A developer including any of the respective magenta toners (magenta toners (M1) to (M8)) and a developer including any of the yellow toners (yellow toners (Y1) and (Y2)) are respectively put into the corresponding developing device and red solid images having an area of 1 in² (2.54 cm×2.54 cm) are respectively formed, as a secondary color, on the image forming apparatus. Specifically, images are formed by adjusting (adjusting developing bias) the adhesion amount of toners (amount of toners placed on the recording medium), at the time when a red solid image (density: 100%) is formed, to be 5.5 g/m². Further, the order of toners to be laminated on the coated paper is a magenta toner and a yellow toner from the coated paper side.

In addition, the coordinate values of CIE1976 L*a*b* color system of the obtained red solid images are obtained by measuring 10 sites of the images using X-RITE 939 (aperture diameter of 4 mm) (manufactured by X-Rite, Inc.), and the average value of the L* value, the a* value and the b* value is calculated.

Subsequently, the obtained red solid images are irradiated with light for 960 hours using SUNTEST CPS+ (manufactured by ATLAS Co., Ltd., light source: 1500 W xenon air-cooled lamp, radiation illuminance of 100 klx, black standard temperature of 42° C., lamp filter: B (outdoor direct light)).

Similar to the red solid images before irradiation with light, the coordinate values of CIE1976 L*a*b* color system of red solid images after irradiation with light are obtained by measuring 10 sites of the images using X-RITE 939 (aperture diameter of 4 mm) (manufactured by X-Rite, Inc.), and the average value of the L* value, the a* value and the b* value is calculated.

A color difference ΔE between a red solid image before irradiation with light and a red solid image after irradiation with light is calculated based on the following equation. Further, a change in color (color difference ΔE) due to irradiation of red solid images with light is evaluated based on the following criteria. The results are listed in Table 1.

ΔE=\sqrt{(L₁−L₂)²+(a₁−a₂)²+(b₁−b₂)²}

In the equation, L₁, a₁, and b₁ respectively represent the L* value, the a* value, and the b* value in the red solid image before irradiation with light, and L₂, a₂, and b₂ respectively represent the L* value, the a* value, and the b* value in the red solid image after irradiation with light,

Evaluation Criteria

G0: The color difference ΔE is 15 or less

G1: The color difference ΔE is greater than 15 and 40 or less

G2: The color difference ΔE is greater than 40

G0 and G1 are not problematic.

Evaluation of Color Reproducibility

Chroma C* of a red solid image is determined based on the following equation from the coordinate values (average value of the L* value, the a* value, and the b* value) of CIE1976 L*a*b* color system of the “red solid images before irradiation with light” obtained in the above-described “evaluation of a change in color tone due to irradiation with light”, and the color reproducibility of the red solid images is evaluated based on the following criteria. The results are listed in Table 1.

C*=((a*)²+(b*)²)^{1/2} Equation:

### Evaluation Criteria

G0: The chroma C* is 85 or greater

G1: The chroma C* is 80 or greater and less than 85

G2: The chroma C* is less than 80

G0 and G1 are not problematic.

TABLE 1

| | | | | | | | | | | | | | | | Evaluation | |
|---|---|---|---|---|---|---|---|---|---|---|---|---|---|---|---|---|
| | | | | | | | | | | | | | | | | Color |
| | Magenta toner | | | | | | | Yellow toner | | | | | | | | difference |
| | | | | λmax | | | | | | | λmax | | | | | ΔE after |
| | | D50v | D84/ | (M) | | | FWHM | | D50v | D84/ | (Y) | | | FWHM | Color | irradiation |
| | Type | (μm) | D50 | (nm) | A₄₅₀ | A₄₀₀ | (nm) | Type | (μm) | D50 | (nm) | A₅₁₀ | A₅₅₀ | (nm) | reproducibility | with light |
| Example 1 | M1 | 150 | 1.25 | 573 | 0.18 | 0.07 | 90 | Y1 | 170 | 1.83 | 456 | 0.09 | 0.03 | 40 | G0 | G1 |
| Example 2 | M2 | 200 | 1.33 | 580 | 0.15 | 0.04 | 100 | Y1 | 170 | 1.83 | 456 | 0.09 | 0.03 | 40 | G0 | G1 |
| Example 3 | M3 | 180 | 1.27 | 534 | 0.19 | 0.08 | 90 | Y1 | 170 | 1.83 | 456 | 0.09 | 0.03 | 40 | G0 | G1 |
| Example 4 | M4 | 230 | 1.35 | 578 | 0.20 | 0.09 | 100 | Y1 | 170 | 1.83 | 456 | 0.09 | 0.03 | 40 | G0 | G1 |
| Example 5 | M5 | 228 | 1.41 | 541 | 0.18 | 0.10 | 100 | Y1 | 170 | 1.83 | 456 | 0.09 | 0.03 | 40 | G0 | G1 |
| Example 6 | M6 | 380 | 1.55 | 577 | 0.18 | 0.06 | 123 | Y1 | 170 | 1.83 | 456 | 0.09 | 0.03 | 40 | G1 | G1 |
| Example 7 | M1 | 150 | 1.25 | 573 | 0.18 | 0.07 | 90 | Y2 | 124 | 1.47 | 435 | 0.19 | 0.03 | 41 | G0 | G0 |
| Comparative | M8 | 173 | 1.33 | 600 | 0.19 | 0.09 | 100 | Y1 | 170 | 1.83 | 456 | 0.09 | 0.03 | 40 | G2 | G1 |
| Example 1 | | | | | | | | | | | | | | | | |
| Comparative | M9 | 118 | 1.05 | 480 | 0.12 | 0.03 | 81 | Y1 | 170 | 1.83 | 456 | 0.09 | 0.03 | 40 | G2 | G2 |
| Example 2 | | | | | | | | | | | | | | | | |
| Comparative | M10 | 235 | 1.37 | 580 | 0.34 | 0.10 | 98 | Y1 | 170 | 1.83 | 456 | 0.09 | 0.03 | 40 | G1 | G2 |
| Example 3 | | | | | | | | | | | | | | | | |
| Comparative | M11 | 204 | 1.37 | 575 | 0.19 | 0.14 | 93 | Y1 | 170 | 1.83 | 456 | 0.09 | 0.03 | 40 | G1 | G2 |
| Example 4 | | | | | | | | | | | | | | | | |
| Comparative | M7 | 228 | 1.49 | 611 | 0.43 | 0.31 | 117 | Y1 | 170 | 1.83 | 456 | 0.09 | 0.03 | 40 | G2 | G2 |
| Example 5 | | | | | | | | | | | | | | | | |

As seen from the above-described results, it is understood that a change in color tone of a red color image due to irradiation with light is prevented in the present examples, compared to Comparative Example 1.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a first image forming unit that forms a yellow toner image by an electrostatic charge image developing yellow toner;
a second image forming unit that forms a magenta toner image by an electrostatic charge image developing magenta toner;
a transfer unit that transfers the yellow toner image and the magenta toner image to a recording medium; and
a fixing unit that fixes the yellow toner image and the magenta toner image to the recording medium,
wherein a maximum absorption wavelength λmax (M) of the electrostatic charge image developing magenta toner at a wavelength of 360 nm to 760 nm is from 530 nm to 580 nm,
when an absorbance of the maximum absorption wavelength λmax (M) is standardized to 1, an absorbance at a wavelength of 450 nm is 0.20 or less and an absorbance at a wavelength of 400 nm is 0.10 or less,
the magenta toner comprises a magenta colorant and a binder resin,
wherein the D84v/D50v of the magenta colorant is from 1 to 2,
wherein the article diameter at which the cumulative volume distribution reaches 84% of the total particle volume is defined as D84v, and
the particle diameter at which the cumulative volume distribution reaches 50% of the total particle volume is defined as D50v, and
the yellow toner comprises a yellow colorant and a binder resin.

2. The image forming apparatus according to claim 1, wherein the full width at half maximum of an absorption peak in the maximum absorption wavelength λmax (M) of the electrostatic charge image developing magenta toner is 100 nm or less.

3. The image forming apparatus according to claim 1, wherein a maximum absorption wavelength λmax (Y) of the electrostatic charge image developing yellow toner at a wavelength of 360 nm to 760 nm is from 400 nm to 440 nm, and
when the absorbance of the maximum absorption wavelength λmax (Y) is standardized to 1, the absorbance at a wavelength of 510 nm is 0.20 or less and the absorbance at a wavelength of 550 nm is 0.10 or less.

4. The image forming apparatus according to claim 1, wherein the full width at half maximum of an absorption peak in the maximum absorption wavelength λmax (Y) of the electrostatic charge image developing yellow toner is 50 nm or less.

5. An electrostatic charge image developing magenta toner,
wherein a maximum absorption wavelength λmax (M) at a wavelength of 360 nm to 760 nm is from 530 nm to 580 nm,
when the absorbance of the maximum absorption wavelength λmax (M) is standardized to 1, the absorbance at a wavelength of 450 nm is 0.20 or less and the absorbance at a wavelength of 400 nm is 0.10 or less, and
the magenta toner comprises a magenta colorant and a binder resin,
wherein the D84v/D50v of the magenta colorant is from 1 to 2,
wherein the particle diameter at which the cumulative volume distribution reaches 84% of the total particle volume is defined D84v, and
the article diameter at which the cumulative volume distribution reaches 50% of the total particle volume is defined as D50v.

6. The electrostatic charge image developing magenta toner according to claim 5, wherein the full width at half maximum of an absorption peak in the maximum absorption wavelength λmax (M) is 100 nm or less.

7. An electrostatic charge image developing toner set, comprising:
the electrostatic charge image developing magenta toner according to claim 5; and
an electrostatic charge image developing yellow toner,
wherein a maximum absorption wavelength λmax (Y) of the electrostatic charge image developing yellow toner at a wavelength of 360 nm to 760 nm is from 400 nm to 440 nm, and
when an absorbance of the maximum absorption wavelength λmax (Y) is standardized to 1, an absorbance at a wavelength of 510 nm is 0.20 or less and an absorbance at a wavelength of 550 nm is 0.10 or less.

8. The electrostatic charge image developing toner set according to claim 7, wherein the full width at half maximum of an absorption peak in the maximum absorption wavelength λmax (Y) of the electrostatic charge image developing yellow toner is 50 nm or less.

9. The image forming apparatus according to claim 1, wherein the binder resin comprises at least one of a homopolymer of monomers, a (meth)acrylic ester, an ethylenically unsaturated nitrile, a vinyl ether, a vinyl ketone, an olefin, a vinyl resin formed of copolymers obtained by combining two or more different monomers, a non-vinyl resin, a mixture of non-vinyl and the vinyl resins, or a graft polymer obtained by polymerizing a vinyl monomer in the co-presence of a non-vinyl resin.

10. The image forming apparatus according to claim 1, wherein the magenta colorant comprises at least one of a β-naphthol pigment, an azo lake pigment, a quinacridone pigment, a disazo pigment, a benzimidazolone pigment, a diazo condensation pigment, a dioxazine pigment, or a diketopyrrolopyrrole pigment.

11. The electrostatic charge image developing magenta toner according to claim 5, wherein the binder resin comprises at least one of a homopolymer of monomers, a (meth)acrylic ester, an ethylenically unsaturated nitrile, a vinyl ether, a vinyl ketone, an olefin, a vinyl resin formed of copolymers obtained by combining two or more different monomers, a non-vinyl resin, a mixture of non-vinyl and the vinyl resins, or a graft polymer obtained by polymerizing a vinyl monomer in the co-presence of a non-vinyl resin.

12. The electrostatic charge image developing magenta toner according to claim 5, wherein the magenta colorant comprises at least one of a β-naphthol pigment, an azo lake pigment, a quinacridone pigment, a disazo pigment, a benzimidazolone pigment, a diazo condensation pigment, a dioxazine pigment, or a diketopyrrolopyrrole pigment.

13. The image forming apparatus according to claim 1, wherein the D84v/D50v of the magenta colorant is from 1 to 1.6.

14. The image forming apparatus according to claim 1, wherein the D84v/D50v of the magenta colorant is from 1 to 1.41.

15. The image forming apparatus according to claim 1, wherein the D84v/D50v of the magenta colorant is from 1 to 1.3.

16. The electrostatic charge image developing magenta toner according to claim 5, wherein the D84v/D50v of the magenta colorant is from 1 to 1.6.

17. The electrostatic charge image developing magenta toner according to claim 5, wherein the D84v/D50v of the magenta colorant is from 1 to 1.41.

18. The electrostatic charge image developing magenta toner according to claim 5, wherein the D84v/D50v of the magenta colorant is from 1 to 1.3.
